(19) United States
(12) Patent Application Publication
(10) Pub. No.: US 2024/0346252 A1
(43) Pub. Date: Oct. 17, 2024

(54) AUTOMATED ANALYSIS OF COMPUTER SYSTEMS USING MACHINE LEARNING

(71) Applicant: Pendo.io, Inc., Raleigh, NC (US)

(72) Inventors: Inbal Budowski-Tal, Tel Aviv (IL); Dana Racah, Ramat Gan (IL); Inon Peled, Tel Aviv (IL)

(21) Appl. No.: 18/638,459

(22) Filed: Apr. 17, 2024

Related U.S. Application Data
(60) Provisional application No. 63/459,943, filed on Apr. 17, 2023.

(51) Int. Cl. G06F 40/30; G06F 40/205; G06N 20/00

(52) U.S. Cl. CPC G06F 40/30; G06F 40/205; G06N 20/00

(57) ABSTRACT

In an example method, a system accesses a plurality of data vectors representing a plurality of text segments; clusters the plurality of data vectors into one or more clusters; determines semantic topic of each of the one or more clusters; generates a data structure representing the semantic topic of each of the one or more clusters; and stores the data structure. Determining the semantic topic of a cluster includes: parsing fields of the data vectors of the cluster, determining a first word representing the cluster, determining a first value representing a frequency of the first word in a training data set, comparing the first value to a threshold value. Responsive to determining that the first value is less than the threshold value, the first word is identified as a semantic topic of the cluster.

### TECHNICAL FIELD

The disclosure relates to systems and methods for automatically determining a semantic topic of textual content using a computer system.

### BACKGROUND

In general, users can generate textual content using a computer system. For instance, using a computer system, a user can input a sequence of words, phrases, sentences, paragraphs, etc. representing one or more subjects or ideas.

Further, the user can share the textual content to with one or more other users using a computer system. For instance, a user can transmit textual content to and/or receive textual content from other users using a computerized communications network (e.g., the Internet, a local area network, a wide area network, etc.).

### SUMMARY

Systems and techniques for automatically determining a semantic topic of textual content are described herein.

In general, users can generate unstructured textual content pertaining to any number of topics. As an example, users can generate text describing their satisfaction with a particular product or service (e.g., in response to a user satisfaction survey). As another example, users can generate social media content (e.g., posts, messages, etc.) containing text. As another example, users can generate text describing patients' medical conditions or medical histories (e.g., as a part of an electronic medical record).

A computer system can automatically determine a semantic topic of the unstructured text context using one or more of the techniques described herein.

As an example, a computer system can pre-process the text (e.g., by tokenizing the text, lemmatizing the text, and/or filtering the text). Further, the computer system can generate data vectors representing the pre-processed text, and cluster the data vectors into one or more clusters (e.g., based on similarities and/or differences between the data vectors). Further, for each of the clusters, the computer system can identify a word that represents the semantic topic of the text represented by that cluster.

In particular, for each of the clusters, the computer system can identify a word that appears most frequently among the pre-processed text that is represented by that cluster, and determine whether the frequency at which the identified word appears in a training data set (e.g., a training data set that includes example unstructured textual content provided by users in a similar context). If the frequency of identified word in the training data set is less than a particular threshold value, the computer system can select the identified word as the semantic topic of the cluster. In contrast, if the frequency of identified word in the training data set is greater than or equal to the threshold value, the computer system can select the word that appears the second most frequently among the text that is represented by that cluster, and compare the frequency of that word in the training data set to the threshold value. The computer system can continue this process until a word is selected as the semantic topic of the cluster.

The implementations described in this disclosure can provide various technical benefits. In some implementations, the systems and techniques described herein enable a computer system to automatically identify a semantic topic of unstructured textual content, without requiring manual user input or intervention. This can be beneficial, for example, in automatically generating a summary of large collections of text (e.g., by identifying one or more semantic topics expressed in the text), without requiring that a user manually review the text in detail.

Further, the implementations described herein can be performed objectively (e.g., based on a specific set of rules), rather than relying on the subjective interpretation of a user. Accordingly, the implementations describe herein are particularly suitable for performance by a computer system to achieve a result having a degree of accuracy that might otherwise require subjective human input.

Further still, the implementations described herein can be performed without the aid of a computerized neural network, which may be resource intensive to deploy and maintain. For example, a computerized neural network may utilize considerable computational resources, memory resources, etc. to deploy and maintain, which may not be required in at least some of the implementations of the computer systems described herein. Accordingly, the computer systems described herein can be operated in a more efficient manner (e.g., compared to computer systems that rely on a computerized neural network to interpret text). Nevertheless, in some implementations, the techniques described herein can be used in conjunction with computerized neural networks to interpret collections of text (e.g., to provide a diversity of computer feedback in order to interpret text more accurately and/or reliably in a variety of use cases or conditions).

In an aspect, a method is performed by a data processing system. The method includes: accessing, by the data processing system from one or more hardware storage devices, a plurality of data vectors representing a plurality of text segments; clustering, by the data processing system, the plurality of data vectors into one or more clusters; determining a semantic topic of each of the one or more clusters, where determining the semantic topic of each of the one or more clusters includes, for each of the one or more clusters: (i) parsing, by a parser of the data processing system, fields of the data vectors of the cluster, (ii) determining, based on the parsing, a first word representing the cluster, (iii) determining a first value representing a frequency of the first word in a training data set, (iv) comparing the first value to a threshold value, and (v) at least one of: responsive to determining that the first value is less than the threshold value, identifying the first word as a semantic topic of the cluster, or responsive to determining that the first value is greater than or equal to the threshold value, identifying another word as the semantic topic of the cluster; generating, by the data processing system, a data structure representing the semantic topic of each of the one or more clusters; and storing, by the data processing system in the one or more hardware storage devices, the data structure.

Implementation of this aspect can include one or more of the following features.

In some implementations, determining the first word representing the cluster can include: determining that the cluster is associated with a first subset of the data vectors, and determining that the first word appears most frequently from among the words in the first subset of the data vectors.

In some implementations, identifying another word as the semantic topic of the cluster can include: determining that a second word appears second most frequently from among the words in the first subset of the data vectors, determining a second value representing a frequency of the second word in the training data set, comparing the second value to the threshold value, and at least one of: responsive to determining that the second value is less than the threshold value, identifying the second word as a semantic topic of the cluster, or responsive to determining that the second value is greater than or equal to the threshold value, identifying another word as the semantic topic of the cluster.

In some implementations, the method can also include, for at least one of the one or more clusters: responsive to determining that the first value is greater than or equal to the threshold value, determining the semantic topic of the cluster was not found, and where the data structure representing that semantic topic of the cluster was not found.

In some implementations, identifying another word as the semantic topic of the cluster can include: re-clustering the plurality of data vectors into one or more second clusters; and determining the semantic topic of each of the one or more second clusters.

In some implementations, clustering the plurality of data vectors into the one or more clusters can include clustering the plurality of data structures based on similarities between the plurality of data structures.

In some implementations, clustering the plurality of data vectors into the one or more clusters can include clustering the plurality of data structures based on similarities between the plurality of data structures using non-negative matrix factorization.

In some implementations, the method can further include generating the plurality of data vectors based on the plurality of text segments.

In some implementations, generating the plurality of data vectors can include at least one of: tokenizing the plurality of text segments, lemmatizing the plurality of text segments, or filtering the plurality of text segments.

In some implementations, generating the plurality of data vectors can include determining a term frequency-inverse document frequency (TF-IDF) of each of the text segments.

In some implementations, each of the text segments can represent a respective first user's satisfaction with one or more products or services.

In some implementations, each of the text segments can be received in response to a user satisfaction survey regarding the one or more products or services.

In some implementations, the user satisfaction survey can include: a first prompt for a numerical score representing a user's satisfaction with the one or more products or services, and a second prompt for textual input.

In some implementations, the training data set can include a plurality of additional text segments, where each of the additional text segments represents a respective additional user's satisfaction with the one or more products or services.

In some implementations, each of the text segments can represent respective first user's social media content.

In some implementations, the training data set can include a plurality of additional text segments, where each of the additional text segments represents a respective additional user's social media content.

In some implementations, each of the text segments can represent respective electronic medical record.

In some implementations, the training data set can include a plurality of additional text segments, where each of the additional text segments represents a respective additional electronic medical record.

Other implementations are directed to systems, devices, and devices for performing some or all of the method. Other implementations are directed to one or more non-transitory computer-readable media including one or more sequences of instructions which when executed by one or more processors causes the performance of some or all of the method.

The details of one or more embodiments are set forth in the accompanying drawings and the description. Other features and advantages will be apparent from the description and drawings, and from the claims.

### BRIEF DESCRIPTION OF DRAWINGS

FIG. 1 is a diagram of an example system for determining a semantic topic of textual content.

FIG. 2 is a diagram of an example parsing engine.

FIG. 3 is a diagram of an example process for determine a semantic topic of textual content.

FIGS. 4A and 4B are plots showing the results of an example validation study that was conducted with respect to topic filtering.

FIG. 5 is a diagram of an example user interface for obtaining user feedback.

FIG. 6 is a flow chart diagram of an example process for determining a semantic topic of textual content.

FIG. 7 is a schematic diagram of an example computer system.

### DETAILED DESCRIPTION

In general, users can generate unstructured textual content pertaining to any number of topics. As an example, users can generate text describing their satisfaction with a particular product or service (e.g., in response to a user satisfaction survey). As another example, users can generate social media content (e.g., posts, messages, etc.) containing text. As another example, users can generate text describing patients' medical conditions or medical histories (e.g., as a part of an electronic medical record).

Although example unstructured textual content is described herein, in practice, unstructured textual content can be generated in the context of any use case or application. Further, unstructured textual content can pertain to any topic, either in addition to or instead of those expressly described herein.

A computer system can automatically determine a semantic topic of the unstructured text context using one or more of the techniques described herein. In general, a semantic topic can the semantic topic of text can refer to one or more words representing a meaning, a concept, and/or a subject of the text. In some implementations, a semantic topic of text can be represented by a single word. In some implementations, a semantic topic of text can be represented by multiple words (e.g., a sequence of words, such as a phrase, sentence, paragraph, etc.).

As an example, a computer system can pre-process the text (e.g., by tokenizing the text, lemmatizing the text, and/or filtering the text). Further, the computer system can generate data vectors representing the pre-processed text, and cluster the data vectors into one or more clusters (e.g., based on similarities and/or differences between the data vectors). Further, for each of the clusters, the computer system can identify a word that represents the semantic topic of the text represented by that cluster.

In particular, for each of the clusters, the computer system can identify a word that appears most frequently among the pre-processed text that is represented by that cluster, and determine whether the frequency at which the identified word appears in a training data set (e.g., a training data set that includes example unstructured textual content provided by users in a similar context). If the frequency of identified word in the training data set is less than a particular threshold value, the computer system can select the identified word as the semantic topic of the cluster. In contrast, if the frequency of identified word in the training data set is greater than or equal to the threshold value, the computer system can select the word that appears the second most frequently among the text that is represented by that cluster, and compare the frequency of that word in the training data set to the threshold value. The computer system can continue this process until a word is selected as the semantic topic of the cluster.

The implementations described in this disclosure can provide various technical benefits. In some implementations, the systems and techniques described herein enable a computer system to automatically identify a semantic topic of unstructured textual content, without requiring manual user input or intervention. This can be beneficial, for example, in automatically generating a summary of large collections of text (e.g., by identifying one or more semantic topics expressed in the text), without requiring that a user manually review the text in detail.

Further, the implementations described herein can be performed objectively (e.g., based on a specific set of rules), rather than relying on the subjective interpretation of a user. Accordingly, the implementations describe herein are particularly suitable for performance by a computer system to achieve a result that might otherwise require subjective human input.

Further still, the implementations described herein can be performed without the aid of a computerized neural network, which may be resource intensive to deploy and maintain. Accordingly, the computer system can be operated in a more efficient manner (e.g., compared to computer systems that rely on a computerized neural network to interpret text). Nevertheless, in some implementations, the techniques described herein can be used in conjunction with computerized neural networks to interpret collections of text (e.g., to provide a diversity of computer feedback in order to interpret text more accurately and/or reliably in a variety of use cases or conditions).

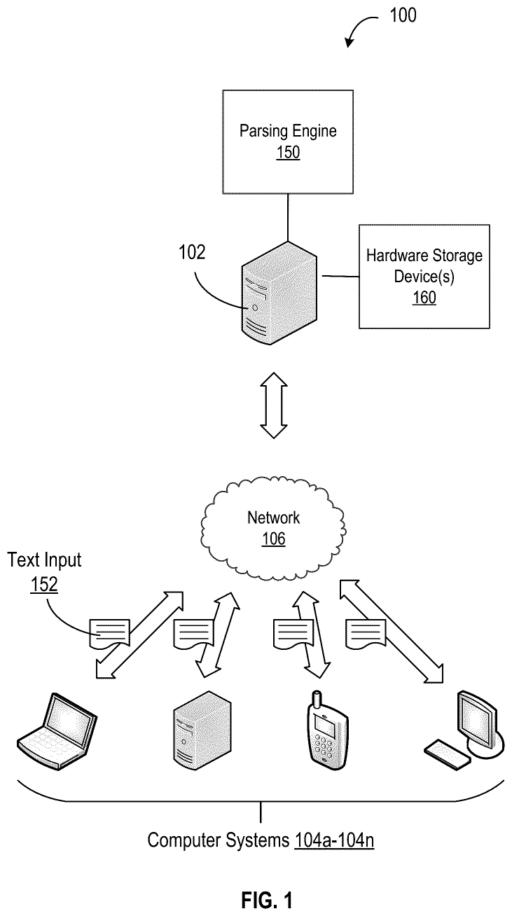

FIG. 1 shows an example system 100 for automatically determining a semantic topic of textual content. The system 100 includes a parsing engine 150 configured to receive text input 152 from one or more computer systems 104a-104n, and to determine one or more semantic topics of the text input 152. The parsing engine 150 can be deployed on a computer system 102, and can be implemented in the form of hardware, software, or a combination thereof. Further, the computer system 150 includes one or more hardware storage devices 160. The computer systems 102 and 104a-104n can be communicatively coupled to another through a network 106.

In an example operation of the system 100, the computer systems 104a-104n generate text input 152. The text input 152 can include unstructured textual content (e.g., textual data that does not have a pre-defined data model and/or is not organized in a pre-defined manner). As an example, the text input 152 can include portions of text (e.g., sequences of words, phrases, sentences, paragraphs, and/or punctuation, etc.) generated by a user regarding one or more topics.

In some implementations, the text input 152 can include a narrative description by a user regarding one or more topics. As an example, at least a portion of the text input 152 can include a user's textual description of their satisfaction with a particular product or service (e.g., in response to a user satisfaction survey). As another example, at least a portion of the text input 152 can include social media content (e.g., posts, messages, etc.) having user generated text. As another example, at least a portion of the text input 152 can include a textual description of a patient's medical condition or medical history (e.g., as a part of an electronic medical record).

In some implementation, at least some of the text input 152 can include one or more sentences or sentence fragments input by a user. In some implementations, at least some of the text input 152 can include one or more words input by a user (e.g., arranged in a list or in a sequence).

The text input 152 can be provided by a user to the computer systems 104a-104n using any data input mechanism or technique. As an example, at least some of the text input 152 can be input by a user using a keyboard, touchscreen, mouse, or other input device. As another example, at least some of the text input 152 can be input by a user using a microphone (e.g., by recording the user's speech and converting the speech into textual content, such as using automatic speech recognition, computer speech recognition, and/or or speech-to-text techniques).

The computer systems 104a-104n transmit the text input 152 to the computer system 102 and the parsing engine 150 for processing. As an example, the parsing engine 150 can receive the text input 152, pre-process the text input 152, and identify one or more semantic topics of the pre-processed text input 152. Further, the parsing engine 150 can generate a data structure (e.g., a data record, data array, database, etc.) representing the text input 152 and/or the identified semantic topics. Further, the parsing engine 150 can present a least a portion of the data structure to a user and/or output at least a portion of the data structure to another computer system (e.g., the computer systems 104a-104n and/or some other computer system). Further, the parsing engine 150 can store at least a portion of the text input 152, the pre-processed text input, the data structure, and/or any other data received by and/or generated by the parsing engine 150 using the one or more hardware storage devices 152.

In general, the semantic topic of text can refer to one or more words representing a meaning, a concept, and/or a subject of the text. In some implementations, a semantic topic of text can be represented by a single word. For example, a passage of text describing that a user satisfaction with a product due to its low price could be represented by the word “price.” As another example, a social media post describing a user's experiences as a baseball game could be represented by the word “baseball.” As another example, in an electronic medical record, a passage of text describing the treatment of a patient suffering from the flu could be represented by the word “flu.” Although example single-word semantic topics are described above, in practice, a semantic topic can include any number of words, phrases, etc.

Example techniques for identifying the semantic topics of text input are described in further detail below.

In general, each of the computer systems 102 and 104a-104n can include any number of electronic device that are configured to receive, process, and transmit data. Examples of the computer systems include client computing devices (e.g., desktop computers or notebook computers), server computing devices (e.g., server computers or cloud computing systems), mobile computing devices (e.g., cellular phones, smartphones, tablets, personal data assistants, notebook computers with networking capability), wearable computing devices (e.g., smart phones or headsets), and other computing devices capable of receiving, processing, and transmitting data. In some implementations, the computer systems can include computing devices that operate using one or more operating systems (e.g., Microsoft Windows, Apple macOS, Linux, Unix, Google Android, and Apple iOS, among others) and one or more architectures (e.g., x86, PowerPC, and ARM, among others). In some implementations, one or more of the computer systems need not be located locally with respect to the rest of the system 100, and one or more of the computer systems can be located in one or more remote physical locations.

Each the computer systems 102 and 104a-104n can include a respective user interface that enables users interact with the computer systems 102 and 104a-104n and/or the parsing engine 150. Example interactions include viewing data, transmit data from one computer system to another, and/or issuing commands to a computer system. Commands can include, for example, any user instruction to one or more of the computer system to perform particular operations or tasks. In some implementations, a user can install a software application onto one or more of the computer systems to facilitate performance of these tasks.

In FIG. 1, the computer systems 102 and 104a-104n are illustrated as respective single components. However, in practice, the computer systems 102 and 104a-104n can be implemented on one or more computing devices (e.g., each computing device including at least one processor such as a microprocessor or microcontroller). As an example, the computer system 102 can be a single computing device that is connected to the network 106, and the parsing engine 150 can be maintained and operated on the single computing device. As another example, the computer system 102 can include multiple computing devices that are connected to the network 106, and the parsing engine 150 can be maintained and operated on some or all of the computing devices. For instance, the computer system 102 can include several computing devices, and the parsing engine 150 can be distributed on one or more of these computing devices.

The network 106 can be any communications network through which data can be transferred and shared. For example, the network 106 can be a local area network (LAN) or a wide-area network (WAN), such as the Internet. The network 106 can be implemented using various networking interfaces, for instance wireless networking interfaces (such as Wi-Fi, Bluetooth, or infrared) or wired networking interfaces (such as Ethernet or serial connection). The network 106 also can include combinations of more than one network, and can be implemented using one or more networking interfaces.

The one or more data storage devices 160 can include any components that configured to store data. Example data storage devices 160 include non-volatile memory, media and memory devices, including by way of example semiconductor memory devices (for example, EPROM, EEPROM, AND flash memory devices), magnetic disks (for example, internal hard disks, and removable disks), magneto optical disks, and CD-ROM and DVD-ROM disks. In some implementations, one or more data storage devices 160 can include volatile memory (e.g., RAM). Although FIG. 1 depicts the one or more data storage devices 160 as being separate from the computer system 102, in practice, the one or more data storage devices 160 can be implemented at least in part as a part of the computer system 102 and/or as a part of one or more other systems (e.g., a cloud computer system, distributed computer system, etc.).

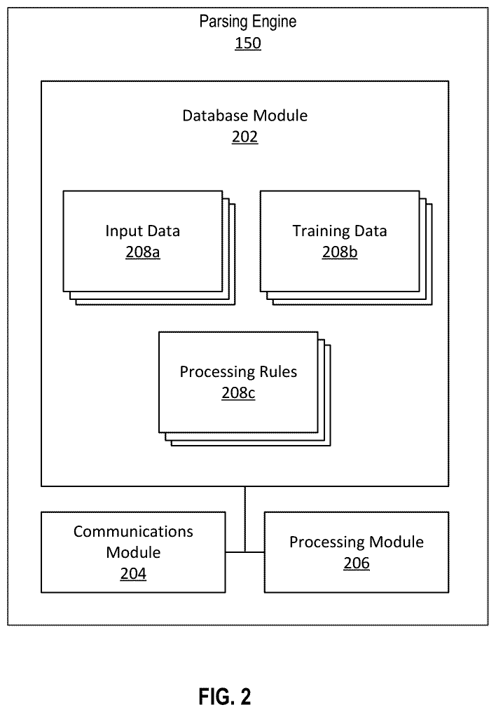

FIG. 2 shows various aspects of the parsing engine 150. The parsing engine 150 includes several operation modules that perform particular functions related to the operation of the parsing engine 150. For example, the parsing engine 150 can include a database module 202, a communications module 204, and a processing module 206. The operation modules can be provided as one or more computer executable software modules, hardware modules, or a combination thereof. For example, one or more of the operation modules can be implemented as blocks of software code with instructions that cause one or more processors of the parsing engine 150 to execute operations described herein. In addition or alternatively, one or more of the operations modules can be implemented in electronic circuitry such as programmable logic circuits, field programmable logic arrays (FPGA), or application specific integrated circuits (ASIC).

The database module 202 maintains information related to automatically determining a semantic topic of textual content. In some implementations, the database module 202 can store at least some information described herein using the one or more hardware storage device 160 shown in FIG. 1.

As an example, the database module 202 can store input data 208a containing unstructured textual content generated by one or more users (e.g., the text input 152 described with reference to FIG. 1). Further, at least some of the input data 208a can be received from one or more computer systems (e.g., the computer systems 104a-104n described with reference to FIG. 1).

Further, the database module 202 can include training data 208b that is used to train the parsing engine 150 to identify a semantic topic of textual content. As an example, the training data 208b can include collections of textual content having a similar context as the input data 208a. For instance, the input data 208a and the training data 208b can include textual content that was generated by users in response to a common prompt and/or in a similar use case.

For example, the input data 208a can include textual content generated by one or more users regarding their satisfaction with a particular product or service (e.g., in response to a user satisfaction survey). Correspondingly, the training data 208b can include additional textual content generated by one or more users regarding their satisfaction with a particular product or service.

As another example, the input data 208a can include social media content (e.g., posts, messages, etc.) having textual content generated by one or more users. Correspondingly, the training data 208b can include additional social media content having textual content generated by one or more users.

As another example, the input data 208a can include textual content generated by one or more users regarding the medical histories or conditions of patients. Correspondingly, the training data 208b can include can include additional textual content generated by one or more users regarding the medical histories or conditions of patients.

In some implementations, at least a portion of the input data 208a and at least a portion of the training data 208b can be generated by the same user or users. In some implementations, at least a portion of the input data 208a and at least a portion of the training data 208b can be generated by different users.

Further, the database module can store processing rules 208c specifying how data in the data stored in the database module 202 can be processed to identify a semantic topic of textual content.

For example, the processing rules 208c can specify how the input data 208a can be pre-processed to generate text segments that are more suitable for interpretation by the parsing engine 150. As an example, the processing rules 208c can instruct the parsing engine 150 to tokenize, lemmatize, and/or filter the input data 208a in a particular manner (e.g., to regularize the textual content and/or to remove noisy input data).

As another example, the processing rules 208c can instruct the parsing engine 150 to generate one or more data vectors that represent the pre-processed text segments. As an example, each data vector can indicate at least some of the words that are included in a particular portion of textual content, and the frequency by which that word appears in that portion of textual content.

As another example, the processing rules 208c can instruct the parsing engine 150 to cluster the one or more data vectors into one or more clusters (e.g., based on the similarities and/or differences between the data vectors).

As another example, the processing rules 208c can specify rules for identifying a word (or words) that represent a semantic topic of a particular cluster. For example, for each cluster, the processing rules 208c can instruct the parsing engine 150 to identify a word that appears most frequently among the text segments that are represented by that cluster, and determine whether the frequency at which the identified word appears in training data 208b (e.g., a training data set that includes example unstructured textual content provided by users in a similar context). Further, the processing rules 208c can specify that, if the frequency of identified word in the training data 208b is less than a particular threshold value, the parsing engine 150 is to select the identified word as the semantic topic of the cluster. Further, the processing rules 208c can specify that, if the frequency of identified word in the training data 208b is greater than or equal to the threshold value, the parsing engine 150 is to select the word that appears the second most frequently among the text that is presented by that cluster, and compare the frequency of that word in the training data 208b to the threshold value. Further, the parsing engine 150 can specify that the parsing engine 150 repeat this process until a word is selected as the semantic topic of the cluster.

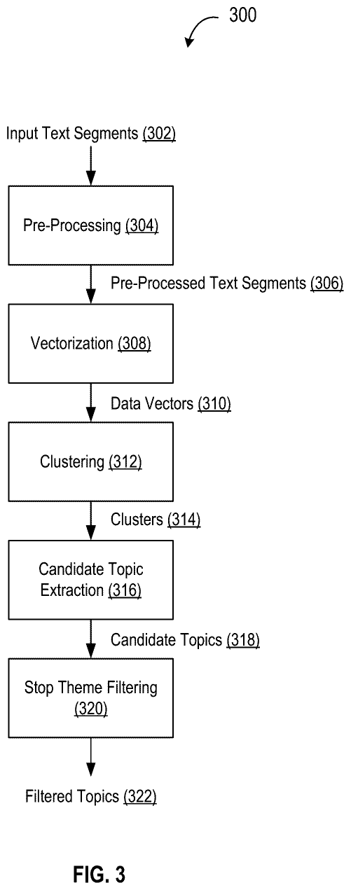

Additional details regarding the processing rules 208c are described with reference to FIG. 3.

As described above, the parsing engine 150 also includes a communications module 204. The communications module 204 allows for the transmission of data to and from the parsing engine 150. For example, the communications module 204 can be communicatively connected to the network 106, such that it can transmit data to and receive data from each of the computer systems 104a-104n. Information received from these computer systems can be processed (e.g., using the processing module 206) and stored (e.g., using the database module 202).

As described above, the parsing engine 150 also includes a processing module 206. The processing module 206 processes data stored or otherwise accessible to the parsing engine 150. For instance, the processing module 206 can process the input data 208a and the training data 208b in accordance with the processing rules 208c in order to identify one or more semantic topics of the input data 208a.

In some implementations, a software application can be used to facilitate performance of the tasks described herein. As an example, an application can be installed on the computer system 102 and/or computer systems 104a-104n. Further, a user can interact with the application to input data and/or commands to the parsing engine 150, and review data generated by the parsing engine 150.

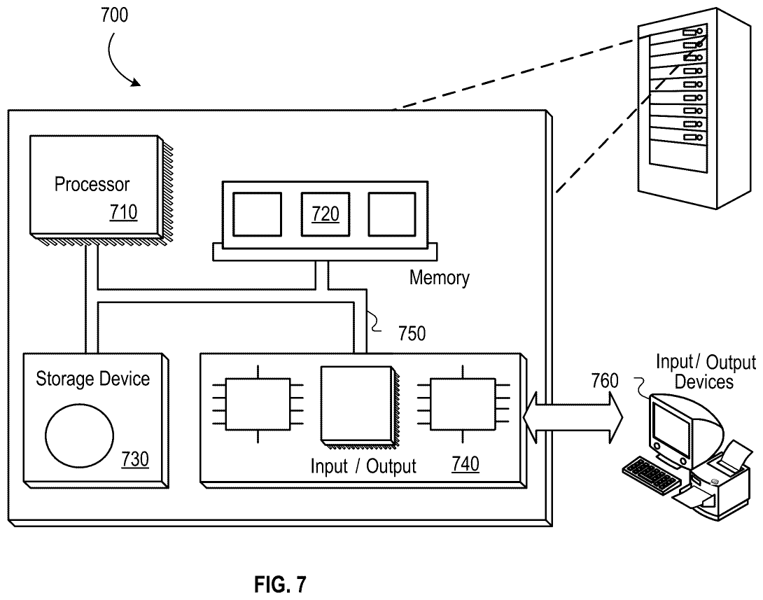

An example process 300 for determining a semantic topic of textual content is shown in FIG. 3. In some implementations, the process 300 can be performed by the system 100 described in this disclosure (e.g., the system 100 including the parsing engine 150 shown and described with reference to FIGS. 1 and 2) using one or more processors (e.g., using the processor or processors 710 shown in FIG. 7). For example, the process 300 can be defined using the processing rules 208c stored in the database module 202, and can be performed using the processing module 206 using the input data 208a and the training data 208b.

According to the process 300, a computer system receives several input text segments (302). As described above, the input text segments can include unstructured textual content generated by one or more users. For instance, the input text segments can include at least a portion of the text input 152 (e.g., as described with reference to FIG. 1) and/or the input data 208a (e.g., as described with reference to FIG. 2). In some implementation, each input text segment can correspond to a respective instance in which a user generated textual content (e.g., a respective user's response to a user satisfaction survey, a respective social media post or message by a user, a respective entry in an electronic medical record, etc.).

The computer system pre-processes the input text segments (304) to generate pre-processed text segments (306). Pre-processing the input texts segments can be beneficial, for example, in regularizing the text segments and/or to remove noisy input data.

In some implementations, the input text segments can be pre-processed by tokenizing the input text segments. For example, each of the input text segments can be separated into smaller units (“tokens”), such as one or more words, characters, suffixes, pre-fixes, roots, sub-words, etc.

In some implementations, the input text segments can be pre-processed by lemmatizing the input text segments. For instance, inflected forms of a word can be grouped together, such that the words can be analyzed as a single item (e.g., identified by the words' lemma or root word).

As an example, a single root word can have multiple inflected forms that represent different respective tenses, cases, voices, aspects, persons, numbers, genders, moods, animacy, and/or definiteness. These inflected forms can be grouped together (e.g., under the common root word) such that they are analyzed as a single item.

For instance, the root word “run” has multiple inflected forms including “run,” “running,” “ran,” “runs,” etc. These inflected forms can be lemmatized by grouping them together into a single group (e.g., a group represented by the root word “run”).

In some implementations, the input text segments can be pre-processed by filtering the input text segments. For example, the input text segments can be filtered according to an exclusion list, whereby words that are included in the exclusion list are filtered out of the input text segments and no longer considered by the parsing engine 150. The exclusion list (also called a “stop word” list) can include words that are unlikely to represent a semantic topic of textual content. As an example, in some implementations, the exclusion list can include one or more articles (e.g., “the,” “a,” “an,” etc.). As another example, in some implementations, the exclusion list can include one or more prepositions (e.g., “on,” “in,” etc.). As another example, in some implementations, the exclusion list can include one or more words that too general and/or vague to represent a semantic topic of textual content (e.g., “like,” “stop,” “use,” etc.).

In some implementations, the exclusion list and the words therein can be specified by one or more users (e.g., an administrator or other user of the parsing engine 150). Further, in some implementations, different exclusion lists having different respective sets of words can be used to process different types of textual content. As an example, a first exclusion list can be used to process user feedback in a user satisfaction survey, a second exclusion list can be used to process social media content, a third exclusion list can be used to process medical records, and so forth.

In some implementations, the input text segments can be pre-processed by tokenizing, lemmatizing, and filtering the input text segments. In some implementations, the input text segments can be pre-processed by performing a subset of tokenizing, lemmatizing, and filtering the input text segments. Further, in some implementations, the input text segments can be further pre-processed by any other data processing technique, either instead of in addition to those described herein.

Further, the computer system receives vectorizes the pre-processed text segments (308) to generate one or more data vectors (310) that represent the pre-processed text segments.

As an example, each pre-processed text segment can be represented by a respective data vector. The data vector can indicate each of the words that are included in the pre-processed text segment, and the frequency by which that word appears in the pre-processed text segment.

As another example, each pre-processed text segment can be represented by a respective data vector. The data vector can indicate each of the words that are included in the pre-processed text segment, and the frequency by which that word appears in a training data set (e.g., the training data 208b described with reference to FIG. 2).

In some implementations, the frequency of word can refer to the number of times that the word appears in a particular collection of textual content

In some implementations, the frequency of a word can refer to the “term frequency-inverse document frequency” (TF-IDF) of that word with respect to a collection of textual content. The TF-IDF of a word is calculated by determining the ratio of (i) a number of times that the word appears in the collection of textual content (“term frequency”), and (ii) an inverse the number of words in the collection of textual content (“inverse document frequency”).

The computer system clusters the data vectors (312) to generate one or more or more clusters (314). As an example, the computer system can cluster the data vectors based on similarities and/or differences between the data vectors. For instance, data vectors that are sufficiently similar to one another (e.g., having a similarity metric above a particular threshold) can be grouped into a common cluster, whereas data vectors that are sufficiently dissimilar to one another (e.g., having a similarity metric less than a particular threshold) can be arranged in different respective clusters. In some implementations, the data vectors can be clustered using a non-negative matrix factorization (NMF) algorithm.

Further, the computer system extracts one or more candidate topics from each of the clusters (316, 318). A candidate topic for a cluster can refer, for example, to a word (or words) that is under consideration by the computer system as the semantic topic of that cluster.

As an example, for each of the clusters, the computer system can generate a list of each of the words that appear in the data vectors of that cluster. Further, for each of those words, the computer system can determine the number of times that the word appears in the text segments and/or data vectors that are represented by that cluster. The computer system can identify one or more of these words as candidate topics of the cluster (e.g., by prioritizing the words in order of the number of times that they appear). For example, the word that appears the greatest number of times can be selected as the first candidate topic of a cluster, followed by the word that appears the second greatest number of times, and so forth.

Further, for each of the clusters, the computer system filters the candidate topics to determine a semantic topic of that cluster (320, 322). In some implementations, this may be referred to as “stop topic filtering.”

The candidate topics can be filtered based on the frequency by which the candidate topic (word) in a training data set (e.g., the training data 208b described with reference to FIG. 2).

For example, the computer system can select the word that appears the greatest number of times in a cluster as the first candidate topic of that cluster. Further, the computer system that determine the frequency (e.g., TF-IDF) of that in the training data set. If the frequency of that word in the training data set is less than a particular threshold value, the computer system can select the identified word as the semantic topic of the cluster. In contrast, if the frequency of identified word in the training data set is greater than or equal to the threshold value, the computer system can select the word that appears the second most frequently among the cluster, and compare the frequency of that word in the training data set to the threshold value. The computer system can continue this process (e.g., by considering the third most frequent word, fourth most frequent work, etc. in a sequence) until a word is selected as the semantic topic of the cluster (or until no candidate topics remain).

This topic filtering processing is particularly useful in identifying words that meaningfully represent the semantic topic of textual content. For example, words that appear the most frequent in a reference collection of textual content (e.g., words having a TF-IDF greater than a particular threshold value with respect to a training data set) are often words that are too general or vague to convey a specific concept or idea. By filtering out these words from consideration, a computer system can identify comparatively less common words (e.g., words having a TF-IDF less than the threshold value with respect to the training data set) that better represent the semantic topic of the textual content. This is particularly beneficial in the context of computer processing, as it enables computer processors to automatically filter out words that may not meaningfully represent the semantic topic of textual content in an objective manner, without relying on manually provided subjective human input (which may be laborious to obtain) and/or without relying on computerized neural networks (which may be resource intensive to deploy and maintain).

In general, the threshold value can be a tunable value. For example, an administrator or other user of the parsing engine 150 can specify a particular threshold value for filtering candidate topics (e.g., based on empirical studies regarding the relationship between the threshold value and the quality of the output of the parsing engine 150). In some implementations, different threshold values can be used to analyze different types of textual content. For example, a first threshold value can be used to filter candidate topics with respect to user satisfaction survey, a second threshold value can be used to filter candidate topics with respect to social media content, a third threshold value can be used to filter candidate topics with respect to medical records, and so forth.

In the example described above, the computer system can sequentially select words based on their frequency in a cluster (e.g., in order from highest frequency to lowest frequency) until a word is selected as the semantic topic of the cluster. However, in some implementations, the computer system can perform other operations when performing stop theme filtering.

For example, the computer system can select the word that appears the greatest number of times in a cluster as the first candidate topic of that cluster. Further, the computer system that determine the frequency (e.g., TF-IDF) of that in the training data set. If the frequency of that word in the training data set is less than a particular threshold value, the computer system can select the identified word as the semantic topic of the cluster. In contrast, if the frequency of identified word in the training data set is greater than or equal to the threshold value, the computer system can indicate that a semantic theme could not be detected for the cluster (e.g., “no theme detected”), and output data representing this determination.

As another example, the computer system can select the word that appears the greatest number of times in a cluster as the first candidate topic of that cluster. Further, the computer system that determine the frequency (e.g., TF-IDF) of that in the training data set. If the frequency of that word in the training data set is less than a particular threshold value, the computer system can select the identified word as the semantic topic of the cluster. In contrast, if the frequency of identified word in the training data set is greater than or equal to the threshold value, the computer system can re-perform clustering (312) to obtain different sets of clusters (e.g., clusters having different sizes, such as smaller sizes, and/or clusters having different sets of data vectors). Further, the computer system can perform candidate topic extraction (316) and stop theme filtering (320) with respect to the new clusters to identify a semantic topic of one or more of the clusters. In some implementations, the computer system can repeat the clustering (312), candidate topic extraction (316), and stop theme filtering (320) processes until a semantic topic of one or more of the cluster is identified.

As another example, the computer system can select the word that appears the greatest number of times in a cluster as the first candidate topic of that cluster. Further, the computer system that determine the frequency (e.g., TF-IDF) of that in the training data set. If the frequency of that word in the training data set is less than a particular threshold value, the computer system can select the identified word as the semantic topic of the cluster. In contrast, if the frequency of identified word in the training data set is greater than or equal to the threshold value, the computer system can perform other operations (e.g., supervised machine learning) to identify a semantic topic of the cluster.

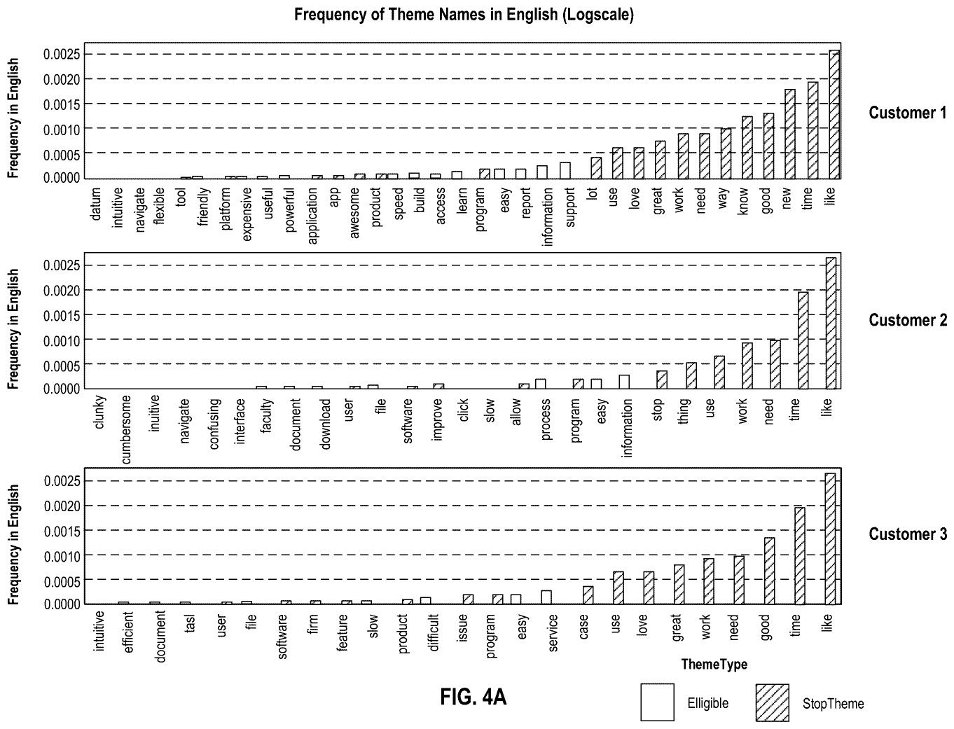

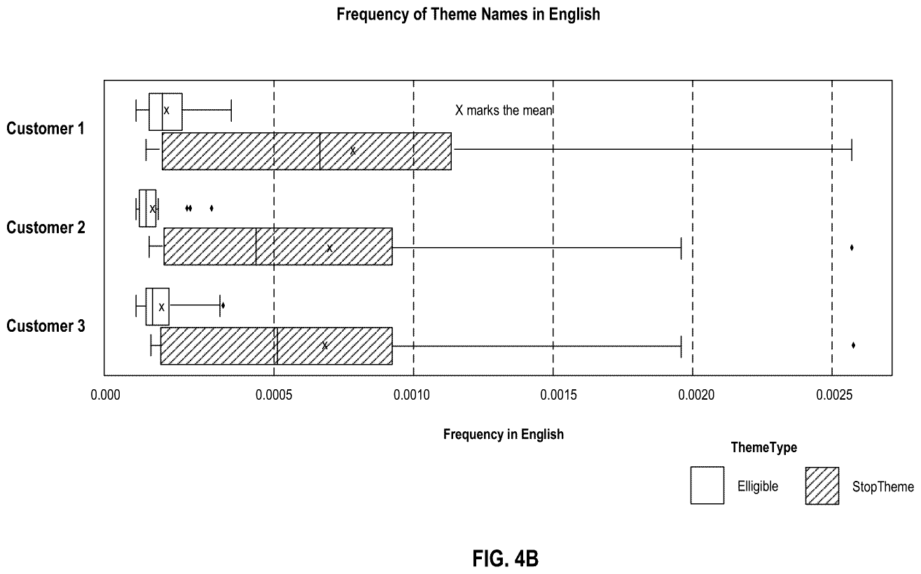

FIGS. 4A and 4B include plots showing the results of an example validation study that was conducted with respect to topic filtering. In this study, human reviewers manually reviewed three collections of textual content (labeled as data from “Customer 1,” Customer 2,” and “Customer 3”) representing user's responses to user satisfaction surveys regarding products and/or services. Further, the human reviewers classified each of words of the collections of textual content as either (i) “eligible” in the context of the word's usage in that textual content (e.g., a word that the user assesses as suitable for representing the semantic topic of the textual content) or (ii) “stop theme” in the context of the word's usage in that textual content (e.g., a word that the user assess as being unsuitable for representing the sematic topic of the textual content). Further, for each of the words, the frequency (e.g., TD-IDF) of the word in the collection was calculated for each classification (e.g., the frequency at which the word appeared as an “eligible” word, and the frequency at which the word appeared to as “stop theme”). That is, a particular word may be considered “eligible” in some contexts, but considered a “stop theme” in other contexts.

As shown in FIGS. 4A and 4B, words that were classified as “stop themes” in their context of use generally appeared more frequently in the collection of textual content, compared to words that were classified as “eligible” in their context of use. Accordingly, in at least some implementations, filtering out candidate topics that appear particularly frequently (e.g., having a TF-IDF above a particular threshold value) may be helpful in identifying a semantic topic for textual content.

As described above, in some implementations, the system and techniques described herein can be used to automatically identify a semantic topic of textual content generated by one or more users regarding their satisfaction with a particular product or service (e.g., in response to a user satisfaction survey). This can be useful, for example, in identify key words that succinctly represent the users' sentiments, without requiring that a human manually review the textual content. Accordingly, a provider of the product or service can better tailor their products or services based on user feedback.

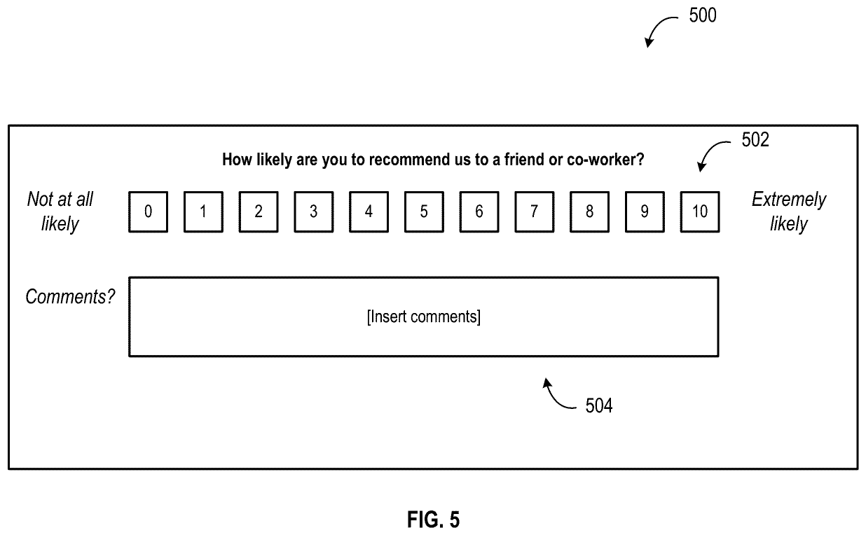

An example user interface 500 for obtaining user feedback is shown in FIG. 5. The user interface 500 includes as first portion 502 for receiving numerical input from a user (e.g., using one or more selectable buttons), and a second portion 504 for receiving textual input from a user (e.g., using a text input box). As an example, the first portion 502 can be used to receive a numerical score representing the user's satisfaction with a product or service (e.g., on a scale of 0 to 10). Further, the second portion 504 can be used to receive an unstructured textual input from the user describing the user's satisfaction with a product or service (e.g., in the form of a narrative description). In some implementations, the user's input in the second portion 504 can be provided to the parsing engine 150 for interpretation (e.g., as the text input 152 and/or input data 208a described with reference to FIGS. 1 and 2, respectively).

In some implementations, the parsing engine 150 can selectively process only a subset of the users' text input, based on the numerical score provided by the users. For example, in some implementations, the parsing engine 150 can process a user's text input if the text input is either (i) associated with a numerical score that is greater than or equal to a first threshold score (e.g., 9), or (ii) associated with a numerical score that is less than or equal to a second threshold score (e.g., 6). This can be useful, for example, in determining the feedback of users who are particularly satisfied with a product or service (e.g., “promoters”) and/or users who are particularly dissatisfied with the product or service (e.g., “detractors”), such that a provider of the product or service can better tailor their products or services based on strong user opinions. Text input that does not satisfy these criteria can be excluded from processing.

Nevertheless, in some implementations, the parsing engine 150 can process a user's text input, regardless of the numerical source provided by the user.

Further, although FIG. 5 describes interpreting textual content representing user feedback regarding products or services, in practice, the techniques described herein can be used to interpret any type of textual content in any context (e.g., social media posts, electronic medical record data, or any other type of textual content).

### Example Processes

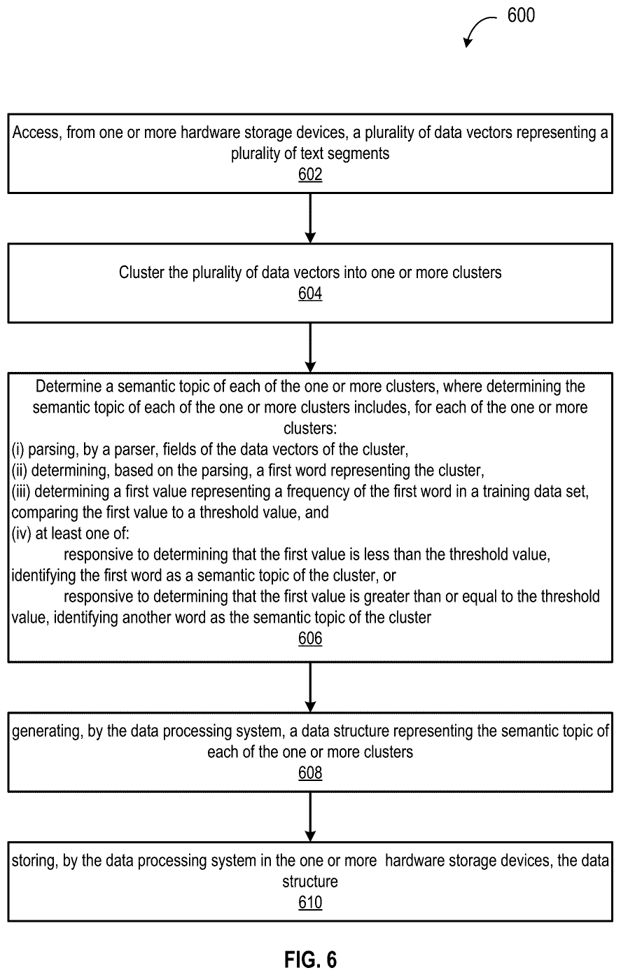

FIG. 6 shows an example process 600 for example process for determining a semantic topic of textual content. In some implementations, the process 600 can be performed by the system 100 described in this disclosure (e.g., the system 100 including the parsing engine 150 shown and described with reference to FIGS. 1 and 2) using one or more processors (e.g., using the processor or processors 710 shown in FIG. 7).

In the process 600, a system accesses, from one or more hardware storage devices, a plurality of data vectors representing a plurality of text segments (block 602).

Further, the system clusters the plurality of data vectors into one or more clusters (block 604).

In some implementations, clustering the plurality of data vectors into the one or more clusters can include clustering the plurality of data structures based on similarities between the plurality of data structures.

In some implementations, clustering the plurality of data vectors into the one or more clusters can include clustering the plurality of data structures based on similarities between the plurality of data structures using non-negative matrix factorization.

Further the system determines a semantic topic of each of the one or more clusters (block 606).

Determining the semantic topic of each of the one or more clusters includes performing the following operations for each of the one or more clusters.

The system parses, by a parser, fields of the data vectors of the cluster,

Further, the system determine based on the parsing, a first word representing the cluster.

Further, the system determines a first value representing a frequency of the first word in a training data set.

Further, the system compares the first value to a threshold value.

Further, the system performs at least one of: responsive to determining that the first value is less than the threshold value, identifying the first word as a semantic topic of the cluster, or responsive to determining that the first value is greater than or equal to the threshold value, identifying another word as the semantic topic of the cluster.

The system generates a data structure representing the semantic topic of each of the one or more clusters (block 608).

Further, the system stores, in the one or more hardware storage devices, the data structure (block 610).

In some implementations, determining the first word representing the cluster can include determining that the cluster is associated with a first subset of the data vectors, and determining that the first word appears most frequently from among the words in the first subset of the data vectors.

In some implementations, identifying another word as the semantic topic of the cluster can include: determining that a second word appears second most frequently from among the words in the first subset of the data vectors; determining a second value representing a frequency of the second word in the training data set; comparing the second value to the threshold value, and at least one of: responsive to determining that the second value is less than the threshold value, identifying the second word as a semantic topic of the cluster, or responsive to determining that the second value is greater than or equal to the threshold value, identifying another word as the semantic topic of the cluster.

In some implementations, the process 600 can also include, for at least one of the one or more clusters: responsive to determining that the first value is greater than or equal to the threshold value, determining the semantic topic of the cluster was not found. Further, the data structure can represent that semantic topic of the cluster was not found.

In some implementations, identifying another word as the semantic topic of the cluster can include re-clustering the plurality of data vectors into one or more second clusters, and determining the semantic topic of each of the one or more second clusters.

In some implementations, the process 600 can also include generating the plurality of data vectors based on the plurality of text segments. In some implementations, the plurality of data vectors can include at least one of: tokenizing the plurality of text segments, lemmatizing the plurality of text segments, or filtering the plurality of text segments. In some implementations, generating the plurality of data vectors can include determining a term frequency-inverse document frequency (TF-IDF) of each of the text segments.

In some implementations, each of the text segments can represent a respective first user's satisfaction with one or more products or services.

In some implementations, each of the text segments can be received in response to a user satisfaction survey regarding the one or more products or services. In some implementations, the user satisfaction survey can include a first prompt for a numerical score representing a user's satisfaction with the one or more products or services, and a second prompt for textual input.

In some implementations, the training data set can include a plurality of additional text segments, where each of the additional text segments represents a respective additional user's satisfaction with the one or more products or services.

In some implementations, each of the text segments can represent respective first user's social media content. In some implementations, the training data set can include a plurality of additional text segments, where each of the additional text segments represents a respective additional user's social media content.

In some implementations, each of the text segments represents respective electronic medical record. In some implementations, the training data set can include a plurality of additional text segments, where each of the additional text segments represents a respective additional electronic medical record.

### Example Systems

Some implementations of the subject matter and operations described in this specification can be implemented in digital electronic circuitry, or in computer software, firmware, or hardware, including the structures disclosed in this specification and their structural equivalents, or in combinations of one or more of them. For example, in some implementations, one or more components of the system 100 (e.g., the parsing engine 150, computer systems 102 and 104a-104n, network 106, etc.) can be implemented using digital electronic circuitry, or in computer software, firmware, or hardware, or in combinations of one or more of them. In another example, the process 600 shown in FIG. 6 can be implemented using digital electronic circuitry, or in computer software, firmware, or hardware, or in combinations of one or more of them.

Some implementations described in this specification can be implemented as one or more groups or modules of digital electronic circuitry, computer software, firmware, or hardware, or in combinations of one or more of them. Although different modules can be used, each module need not be distinct, and multiple modules can be implemented on the same digital electronic circuitry, computer software, firmware, or hardware, or combination thereof.

Some implementations described in this specification can be implemented as one or more computer programs, that is, one or more modules of computer program instructions, encoded on computer storage medium for execution by, or to control the operation of, data processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (for example, multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, for example, an FPGA (field programmable gate array) or an ASIC (application specific integrated circuit). The apparatus can also include, in addition to hardware, code that creates an execution environment for the computer program in question, for example, code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages. A computer program may, but need not, correspond to a file in a file system. A program can be stored in a portion of a file that holds other programs or data (for example, one or more scripts stored in a markup language document), in a single file dedicated to the program in question, or in multiple coordinated files (for example, files that store one or more modules, sub programs, or portions of code). A computer program can be deployed to be executed on one computer or on multiple computers that are located at one site or distributed across multiple sites and interconnected by a communication network.

Some of the processes and logic flows described in this specification can be performed by one or more programmable processors executing one or more computer programs to perform actions by operating on input data and generating output. The processes and logic flows can also be performed by, and apparatus can also be implemented as, special purpose logic circuitry, for example, an FPGA (field programmable gate array) or an ASIC (application specific integrated circuit).

Processors suitable for the execution of a computer program include, by way of example, both general and special purpose microprocessors, and processors of any kind of digital computer. Generally, a processor will receive instructions and data from a read only memory or a random access memory or both. A computer includes a processor for performing actions in accordance with instructions and one or more memory devices for storing instructions and data. A computer can also include, or be operatively coupled to receive data from or transfer data to, or both, one or more mass storage devices for storing data, for example, magnetic, magneto optical disks, or optical disks. However, a computer need not have such devices. Devices suitable for storing computer program instructions and data include all forms of non-volatile memory, media and memory devices, including by way of example semiconductor memory devices (for example, EPROM, EEPROM, AND flash memory devices), magnetic disks (for example, internal hard disks, and removable disks), magneto optical disks, and CD-ROM and DVD-ROM disks. The processor and the memory can be supplemented by, or incorporated in, special purpose logic circuitry.

To provide for interaction with a user, operations can be implemented on a computer having a display device (for example, a monitor, or another type of display device) for displaying information to the user. The computer can also include a keyboard and a pointing device (for example, a mouse, a trackball, a tablet, a touch sensitive screen, or another type of pointing device) by which the user can provide input to the computer. Other kinds of devices can be used to provide for interaction with a user as well. For example, feedback provided to the user can be any form of sensory feedback, such as visual feedback, auditory feedback, or tactile feedback. Input from the user can be received in any form, including acoustic, speech, or tactile input. In addition, a computer can interact with a user by sending documents to and receiving documents from a device that is used by the user. For example, a computer can send webpages to a web browser on a user's client device in response to requests received from the web browser.

A computer system can include a single computing device, or multiple computers that operate in proximity or generally remote from each other and typically interact through a communication network. Examples of communication networks include a local area network (“LAN”) and a wide area network (“WAN”), an inter-network (for example, the Internet), a network including a satellite link, and peer-to-peer networks (for example, ad hoc peer-to-peer networks). A relationship of client and server can arise by virtue of computer programs running on the respective computers and having a client-server relationship to each other.

FIG. 7 shows an example computer system 700 that includes a processor 710, a memory 720, a storage device 730 and an input/output device 740. Each of the components 710, 720, 730 and 740 can be interconnected, for example, by a system bus 750. The processor 710 is capable of processing instructions for execution within the system 700. In some implementations, the processor 710 is a single-threaded processor, a multi-threaded processor, or another type of processor. The processor 710 is capable of processing instructions stored in the memory 720 or on the storage device 730. The memory 720 and the storage device 730 can store information within the system 700.

The input/output device 740 provides input/output operations for the system 700. In some implementations, the input/output device 740 can include one or more of a network interface device, for example, an Ethernet card, a serial communication device, for example, an RS-232 port, or a wireless interface device, for example, an 802.11 card, a 3G wireless modem, a 4G wireless modem, or a 5G wireless modem, or both. In some implementations, the input/output device can include driver devices configured to receive input data and send output data to other input/output devices, for example, keyboard, printer and display devices 760. In some implementations, mobile computing devices, mobile communication devices, and other devices can be used.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable sub-combination.

A number of embodiments have been described. Nevertheless, various modifications can be made without departing from the spirit and scope of the invention. Accordingly, other embodiments are within the scope of the claims.

1. A method performed by a data processing system, the method comprising:
accessing, by the data processing system from one or more hardware storage devices, a plurality of data vectors representing a plurality of text segments;
clustering, by the data processing system, the plurality of data vectors into one or more clusters;
determining a semantic topic of each of the one or more clusters, wherein determining the semantic topic of each of the one or more clusters comprises, for each of the one or more clusters:
parsing, by a parser of the data processing system, fields of the data vectors of the cluster,
determining, based on the parsing, a first word representing the cluster,
determining a first value representing a frequency of the first word in a training data set,
comparing the first value to a threshold value, and
at least one of:
responsive to determining that the first value is less than the threshold value, identifying the first word as a semantic topic of the cluster, or
responsive to determining that the first value is greater than or equal to the threshold value, identifying another word as the semantic topic of the cluster;
generating, by the data processing system, a data structure representing the semantic topic of each of the one or more clusters; and
storing, by the data processing system in the one or more hardware storage devices, the data structure.

2. The method of claim 1, wherein determining the first word representing the cluster comprises:
determining that the cluster is associated with a first subset of the data vectors, and
determining that the first word appears most frequently from among the words in the first subset of the data vectors.

3. The method of claim 2, wherein identifying another word as the semantic topic of the cluster comprises:
determining that a second word appears second most frequently from among the words in the first subset of the data vectors,
determining a second value representing a frequency of the second word in the training data set,
comparing the second value to the threshold value, and
at least one of:
responsive to determining that the second value is less than the threshold value, identifying the second word as a semantic topic of the cluster, or
responsive to determining that the second value is greater than or equal to the threshold value, identifying another word as the semantic topic of the cluster.

4. The method of claim 1, further comprising, for at least one of the one or more clusters:
responsive to determining that the first value is greater than or equal to the threshold value, determining the semantic topic of the cluster was not found, and
wherein the data structure representing that semantic topic of the cluster was not found.

5. The method of claim 1, wherein identifying another word as the semantic topic of the cluster comprises:
re-clustering the plurality of data vectors into one or more second clusters; and
determining the semantic topic of each of the one or more second clusters.

6. The method of claim 1, wherein clustering the plurality of data vectors into the one or more clusters comprises:
clustering the plurality of data structures based on similarities between the plurality of data structures.

7. The method of claim 1, wherein clustering the plurality of data vectors into the one or more clusters comprises:
clustering the plurality of data structures based on similarities between the plurality of data structures using non-negative matrix factorization.

8. The method of claim 1, further comprising generating the plurality of data vectors based on the plurality of text segments.

9. The method of claim 8, wherein generating the plurality of data vectors comprises at least one of:
tokenizing the plurality of text segments,
lemmatizing the plurality of text segments, or
filtering the plurality of text segments.

10. The method of claim 8, wherein generating the plurality of data vectors comprises determining a term frequency-inverse document frequency (TF-IDF) of each of the text segments.

11. The method of claim 1, wherein each of the text segments represents a respective first user's satisfaction with one or more products or services.

12. The method of claim 11, wherein each of the text segments is received in response to a user satisfaction survey regarding the one or more products or services.

13. The method of claim 11, wherein the user satisfaction survey comprises:
a first prompt for a numerical score representing a user's satisfaction with the one or more products or services, and
a second prompt for textual input.

14. The method of claim 11, wherein the training data set comprises a plurality of additional text segments, wherein each of the additional text segments represents a respective additional user's satisfaction with the one or more products or services.

15. The method of claim 1, wherein each of the text segments represents respective first user's social media content.

16. The method of claim 15, wherein the training data set comprises a plurality of additional text segments, wherein each of the additional text segments represents a respective additional user's social media content.

17. The method of claim 1, wherein each of the text segments represents respective electronic medical record.

18. The method of claim 17, wherein the training data set comprises a plurality of additional text segments, wherein each of the additional text segments represents a respective additional electronic medical record.

19. A system, comprising:
at least one processor; and
a memory communicatively coupled to the at least one processor, the memory storing instructions which, when executed by the at least one processor, cause the at least one processor to perform operations comprising:
accessing, from one or more hardware storage devices, a plurality of data vectors representing a plurality of text segments:
clustering the plurality of data vectors into one or more clusters;
determining a semantic topic of each of the one or more clusters, wherein determining the semantic topic of each of the one or more clusters comprises, for each of the one or more clusters:
parsing, by a parser, fields of the data vectors of the cluster,
determining, based on the parsing, a first word representing the cluster,
determining a first value representing a frequency of the first word in a training data set,
comparing the first value to a threshold value, and
at least one of:
responsive to determining that the first value is less than the threshold value, identifying the first word as a semantic topic of the cluster, or
responsive to determining that the first value is greater than or equal to the threshold value, identifying another word as the semantic topic of the cluster:
generating a data structure representing the semantic topic of each of the one or more clusters; and
storing, in the one or more hardware storage devices, the data structure.

20. One or more non-transitory computer-readable media storing instructions which, when executed by at least one processor, cause the at least one processor to perform operations comprising:
accessing, from one or more hardware storage devices, a plurality of data vectors representing a plurality of text segments:
clustering the plurality of data vectors into one or more clusters:
determining a semantic topic of each of the one or more clusters, wherein determining the semantic topic of each of the one or more clusters comprises, for each of the one or more clusters:
parsing, by a parser, fields of the data vectors of the cluster,
determining, based on the parsing, a first word representing the cluster,
determining a first value representing a frequency of the first word in a training data set,
comparing the first value to a threshold value, and
at least one of:
responsive to determining that the first value is less than the threshold value, identifying the first word as a semantic topic of the cluster, or
responsive to determining that the first value is greater than or equal to the threshold value, identifying another word as the semantic topic of the cluster;
generating a data structure representing the semantic topic of each of the one or more clusters; and
storing, in the one or more hardware storage devices, the data structure.
